(19) United States
(12) Patent Application Publication
(10) Pub. No.: US 2008/0316973 A1
(43) Pub. Date: Dec. 25, 2008

(54) Method and Apparatus for Supporting a Handover Using an Interactive Channel in a Dvb-H Cbms System

(76) Inventors: Jong-Hoon Ann, Gyeonggi-do (KR); Jae-Yeon Song, Seoul (KR); Yiling Xu, Gyeonggi-do (KR); Kook-Heui Lee, Gyeonggi-do (KR); Hye-Young Lee, Seoul (KR); Bo-Sun Jung, Gyeonggi-do (KR); Jong-Hyo Lee, Gyeonggi-do (KR)

Correspondence Address: THE FARRELL LAW FIRM, P.C., 333 EARLE OVINGTON BOULEVARD, SUITE 701, UNIONDALE, NY, 11553, US

(21) Appl. No.: 12/160,863

(22) PCT Filed: Jan. 12, 2007
(86) PCT No.: PCT/KR07/00221

§ 371 Date: Jul. 14, 2008

(30) Foreign Application Priority Data
Jan. 12, 2006 (KR) 10-2006-0003685
Jan. 13, 2006 (KR) 10-2006-0003805
Jan. 20, 2006 (KR) 10-2006-0006501

(51) Int. Cl. H04Q 7/00; H04N 7/173

(52) U.S. Cl. 370/331; 725/118

(57) ABSTRACT

An apparatus and method for continuously providing a selected service being watched when a user moves out of a cell or network in a Digital Video Broadcasting-Handheld (DVB-H) Convergence of Broadcasting and Mobile Service (CBMS) system. Information required for a handover is provided to a terminal using an interactive channel. The handover for the terminal can be performed using a conventional scheme and an enhanced scheme even when the user moves to a new cell while watching the selected service. As the enhanced handover scheme is provided, the user can receive a seamless service. In a mobile environment, a handover scenario for the terminal can be efficiently provided.

### CROSS-REFERENCE TO RELATED PATENT APPLICATIONS

The present application is a National Stage filing of PCT International Application No. PCT/KR2007/000221, which claims priority to Korean Patent Applications filed in the Korean Intellectual Property Office on Jan. 12, 2006, Jan. 13, 2006, and Jan. 20, 2006, which are assigned Serial Nos. 2006-3685, 2006-3805, and 2006-6501, respectively, the entire disclosures of which are hereby incorporated by reference.

### BACKGROUND OF THE INVENTION

1. Field of the Invention

The present invention relates generally to a Digital Video Broadcasting-Handheld (DVB-H) Convergence of Broadcasting and Mobile Service (CBMS) system, and more particularly to a method and apparatus for providing handover-related information to a terminal for a handover using an interactive channel.

2. Description of the Related Art

Digital Video Broadcasting-Handheld (DVB-H) Convergence of Broadcasting and Mobile Service (CBMS) is a service providing a more convenient function through the convergence of mobile communication and digital TeleVision (TV) broadcasting services, which has superior mobile reception performance. As analog TVs change to digital form, High Definition TV (HDTV)-level video quality and Compact Disc (CD)-level audio quality can be enjoyed. The activities and living patterns of viewers according to diversification of modern society are different from those in the past. Further, as mobile devices such as a mobile phone, Personal Digital Assistant (PDA), notebook computer, etc. are widely used, demand for clear TV images on the move is rapidly increasing. The DVB-H CBMS has been created as a result of efforts to overcome a limitation of a broadcast network without a reverse channel.

The DVB-H CBMS includes a handover concept that is supportable in cell-based wireless communication as in a conventional mobile communication system developed to enable a receiving terminal to use a mobile communication channel. However, the handover of the DVB-H CBMS is different from that of the mobile communication system.

More specifically, in the handover of the mobile communication system, a network receives a measurement report for network management including the handover while managing individual users. However, in the conventional broadcasting system, a broadcasting provider provides a service and content, but does not manage the individual users. The broadcasting system provides all users with broadcast reception information through a broadcast network, but does not have a user management function. Accordingly, technical specifications are required for the handover of the broadcast network, which is different from that of the mobile communication system. An object of the handover of the broadcast network is to continuously and seamlessly provide a service being watched by a user on the move.

FIG. 1 is a system diagram illustrating a concept of a handover in conventional DVB-H.

Referring to FIG. 1, a user 100 should be able to receive a transport stream of a cell 130, which is equal to that of a different cell 120, such that the user can continuously receive a service selected in the cell 120, being watched when moving to the cell 130 belonging to the same network. When the transport streams are different from each other, the same service should be basically included in the transport stream to be provided from the cell 130. Because transmission frequencies are different between cells, a terminal should know frequency information of a neighbor cell for a handover. The frequency information of the neighbor cell can be acquired from Program Specific Information/Service Information (PSI/SI) provided by a DVB network.

When exiting a network 140 and entering a neighbor network 150, a user 110 should know an IDentifier (ID) of a transport stream of the neighbor network to which a service being watched belongs, as well as the frequency information. The ID can be also detected from the PSI/SI. If the service being watched by the user is absent in the neighbor network, the terminal performs a process for retrieving an alternative service. Herein, an example of the alternative service is a service such as regional news programs whose contents are different from each other but genres are the same as each other. A roaming procedure may be required in the case of a connection to another network. An object of the above-described handover is to seamlessly and continuously provide a service being watched, even when the user is on the move.

FIG. 2 is a flow diagram illustrating a message exchange procedure for a conventional handover.

Referring to FIG. 2. A contents source 200 of a service application provides the user with content to be watched. A PSI/SI generator 210 within a broadcast network collects PSI/SI and sends the collected PSI/SI to a terminal through the broadcast network. In the terminal, a contents consumption 220 is used to watch content provided by a broadcasting service provider. A PSI/SI handler 230 is responsible for an associated service operation and a decoding operation on a received broadcast signal on the basis of information acquired by receiving the PSI/SI from the broadcast network. A mobility manager 240 is an entity for continuously providing a service, even when the terminal is on the move.

In step 250, the terminal receives a service from the contents source 200 and receives a selected program before a handover state is entered. While the program is being watched and the strength of a received signal is weakened, the terminal selects candidate cells suitable for its location on the basis of PSI/SI (PSI/SI_before) in step 260. In step 270, the terminal measures signal strengths received from the candidate cells during an off time. When a cell suitable for a measurement result is retrieved, a frequency is tuned and the handover is performed. In the drawings of message exchange procedures for explanation of the present invention, the dotted line divides a pre-handover procedure and a post-handover procedure.

After the handover is performed, the terminal detects a transport stream to be received and continuously receives the detected transport stream. In step 280, the terminal receives PSI/SI (PSI/SI_after) of a new cell and performs a decoding process based on the received information. After completing the decoding process, the terminal receives a service from the new cell in step 290, such that the user can seamlessly receive the selected service.

Herein, it is assumed that a PSI/SI transmission/reception process, including the PSI/SI reception process of steps 260 and 280, is continuously performed through the broadcast network. For convenience of explanation, an example in which the PSI/SI is received after completing a specific procedure has been described. Alternatively, this process may be continuously performed during broadcast reception.

FIG. 3 is a flowchart illustrating an operation of the terminal when the conventional handover is performed.

Referring to FIG. 3, the terminal receives a broadcast service in step 300 and periodically determines whether the strength of a received signal is weakened in step 310. If the received signal strength is not weakened, the terminal continuously receives the broadcast service in step 300. However, if the reception signal is weakened, the terminal acquires frequency information of a neighbor cell or network from PSI/SI in step 320. The cell or network whose frequency information is known belongs to a candidate group for the handover. Upon acquiring the frequency information from the PSI/SI, the terminal measures the signal strength received from the neighbor cell or network during an off time in step 330.

In step 311, the terminal determines whether measured signal strength at the received frequency is greater than a predefined threshold among the measured strengths of signals received from the candidate group. If the measured signal strength is greater than the predefined threshold, the terminal determines if a service being watched by the user is present at that frequency in step 312. However, if the measured signal strength is not greater than the predefined threshold, the terminal performs an initial setup process in step 350.

More specifically, in step 350, the broadcast service is no longer received because the signal strength of a received signal is less than the threshold. Thus, the terminal returns to the initial step of detecting the broadcast service and repeats the setup process. When the reception of the broadcast service can be resumed through step 350, the terminal receives the broadcast service in step 300. However, when the terminal performs step 350, the user can experience a disconnection of the service being watched.

However, if the frequency is retrieved at a strength greater than the predefined threshold, but the service being watched by the user is not included at the associated frequency in step 312, the terminal may also perform step 350, and a subsequent process, such that a service disconnection are the same as described above.

If the frequency is retrieved at a strength greater than the predefined threshold, and the service being watched by the user is included at the associated frequency in step 312, the terminal performs a tuning operation in step 340. The tuning operation enables the service to be continuously received by shifting a reception frequency and detecting an associated transport stream being watched by the user. After step 340, the handover process is completed. Thereafter, the terminal continuously receives the service in step 300.

FIG. 4 is a flowchart illustrating an operation of the network upon the conventional handover.

Referring to FIG. 4, when the network is started, the network transmits a broadcast service in step 400 and simultaneously transmits PSI/SI in step 410. That is, the network only transmits the broadcast service and essential/additional information for the conventional handover.

As described above, the conventional handover technology may provide a handover service to account for the movement of a user. However, there is a problem in that a handover may fail when required information is not received through PSI/SI, upon the handover, and therefore, a service being watched may not be seamlessly provided.

### SUMMARY OF THE INVENTION

Accordingly, the present invention has been designed to address at least the above problems and/or disadvantages, and to provide at least the advantages described below. An aspect of the present invention is to provide a method and apparatus that provide a terminal with information for a handover through an interactive channel in a Digital Video Broadcasting-Handheld (DVB-H) Convergence of Broadcasting and Mobile Service (CBMS) system.

Another aspect of the present invention is to provide a method and apparatus that transmit requested information to a terminal desiring to receive handover-related information using an interactive channel for a handover in a DVB-H CBMS system.

Another aspect of the present invention is to provide a method and apparatus that enable a user to watch a seamless service when the user moves out of a particular cell area while watching a selected service using an interactive channel serving as a mobile communication channel in a DVB-H CBMS system.

Another aspect of the present invention is to provide a method and apparatus that enable a user to watch a seamless service when the user moves out of a particular cell area while watching a selected service using an active handover scheme in a DVB-H CBMS system.

In accordance with an aspect of the present invention, a method for performing a handover for a terminal in a DVB-H CBMS system is provided. The method includes checking a received strength of a broadcast service currently being received; sending a request for handover-related information from the terminal to a network through an interactive channel; selecting new handover candidate cells based on the handover-related information received from the network through the interactive channel; measuring strengths of broadcast service signals received from the candidate cells; performing a tuning operation for detecting a transport stream of the service currently being received by shifting a reception frequency to a retrieved frequency, when the frequency is retrieved at a strength higher than the reference value; completing the handover; and continuously receiving the service currently being received using a channel generated through the handover.

In accordance with another aspect of the present invention, a method for supporting a handover for a terminal in a network of a DVB-H CBMS system is provided. The method includes transmitting a broadcast service and program specific information (PSI)/service information (SI); receiving a message for requesting handover-related information from the terminal; generating a channel for providing the terminal with the broadcast service; and transmitting the broadcast service, the PSI/SI, and the handover-related information through the generated channel.

In accordance with another aspect of the present invention, a method for supporting a handover for a terminal in a network of a DVB-H CBMS system is provided. The method includes transmitting a broadcast service and PSI/SI; receiving a handover request message from the terminal through an interactive channel; generating a channel for providing the terminal with the broadcast service; and providing the terminal with a handover channel identifier and handover time information, along with the broadcast service through the generated channel.

In accordance with another aspect of the present invention, a DVB-H CBMS system for supporting a handover is provided. The system includes a terminal for requesting at least one of a passive handover and an active handover; and a network for transmitting a broadcast service and PSI/SI, generating a channel for providing the terminal with the broadcast service, and transmitting the broadcast service and the PSI/SI through the generated channel. The network transmits handover-related information through the generated channel when receiving the passive handover request from the terminal and provides the terminal with a handover channel identifier and handover time information along with the broadcast service through the generated channel, when receiving the active handover request from the terminal.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a system diagram illustrating a concept of a handover in conventional Digital Video Broadcasting-Handheld (DVB-H) system;

FIG. 2 is a flow diagram illustrating a message exchange procedure for a conventional handover;

FIG. 3 is a flowchart illustrating an operation of a conventional terminal;

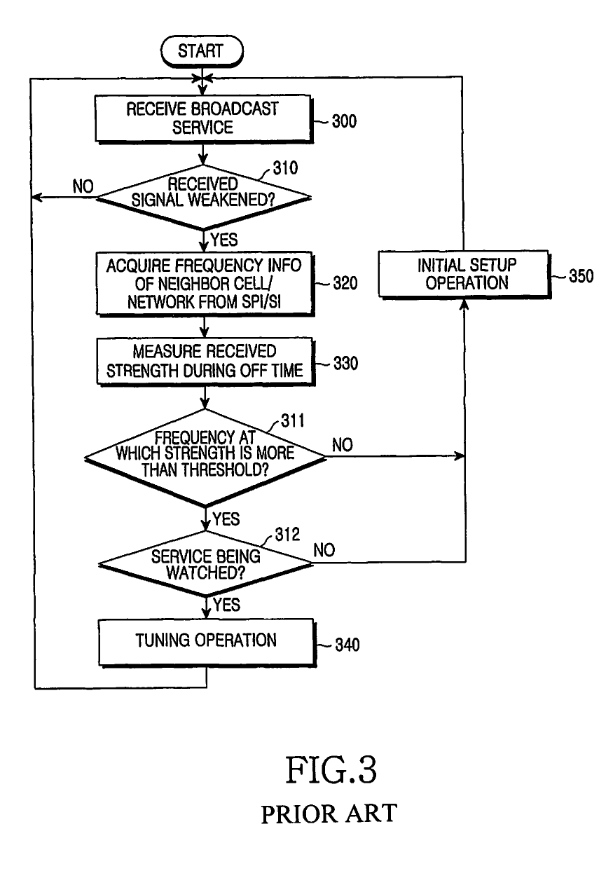

FIG. 4 is a flowchart illustrating an operation of a conventional network;

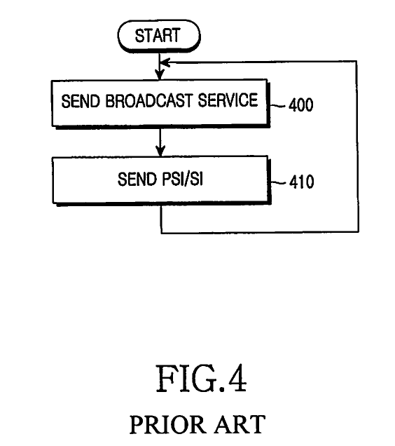

FIG. 5 is a schematic flowchart illustrating a handover procedure in accordance with an exemplary embodiment of the present invention;

FIG. 6 is a flow diagram illustrating a message exchange procedure for a passive handover in accordance with an exemplary embodiment of the present invention;

FIG. 7 is a flowchart illustrating an operation of a terminal during a passive handover in accordance with an exemplary embodiment of the present invention;

FIG. 8 is a flowchart illustrating an operation of a network during a passive handover in accordance with an exemplary embodiment of the present invention;

FIG. 9 is a flow diagram illustrating a message exchange procedure for an active handover in accordance with an exemplary embodiment of the present invention;

FIG. 10 is a flowchart illustrating an operation of a terminal during an active handover in accordance with an exemplary embodiment of the present invention; and

FIG. 11 is a flowchart illustrating an operation of a network during an active handover in accordance with an exemplary embodiment of the present invention.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Information required for a handover in exemplary embodiments of the present invention as will be described below is not limited to program specific information/service information (PSI/SI) in a digital video broadcasting-handheld (DVB-H) convergence of broadcasting and mobile service (CBMS) system. Exemplary embodiments of the present invention provide a method and apparatus that can transmit essential/additional information to a terminal for a handover under assumption that an interactive channel is provided.

However, before the exemplary embodiments of the present invention are described in detail, the concepts of passive and active handovers need to be established.

A passive handover is a terminal-controlled handover in which a neighbor transport stream and a transport stream carrying service related information are provided. A representative method for transmitting information in the transport stream uses PSI/SI. When the passive handover is applied, an access parameter can be provided through the interactive channel.

The active handover is a scheme for controlling a handover in an Internet Protocol Data Casting (IPDC) service network. In the active handover, the interactive channel is essential. Broadcast content using the interactive channel can be provided through the active handover.

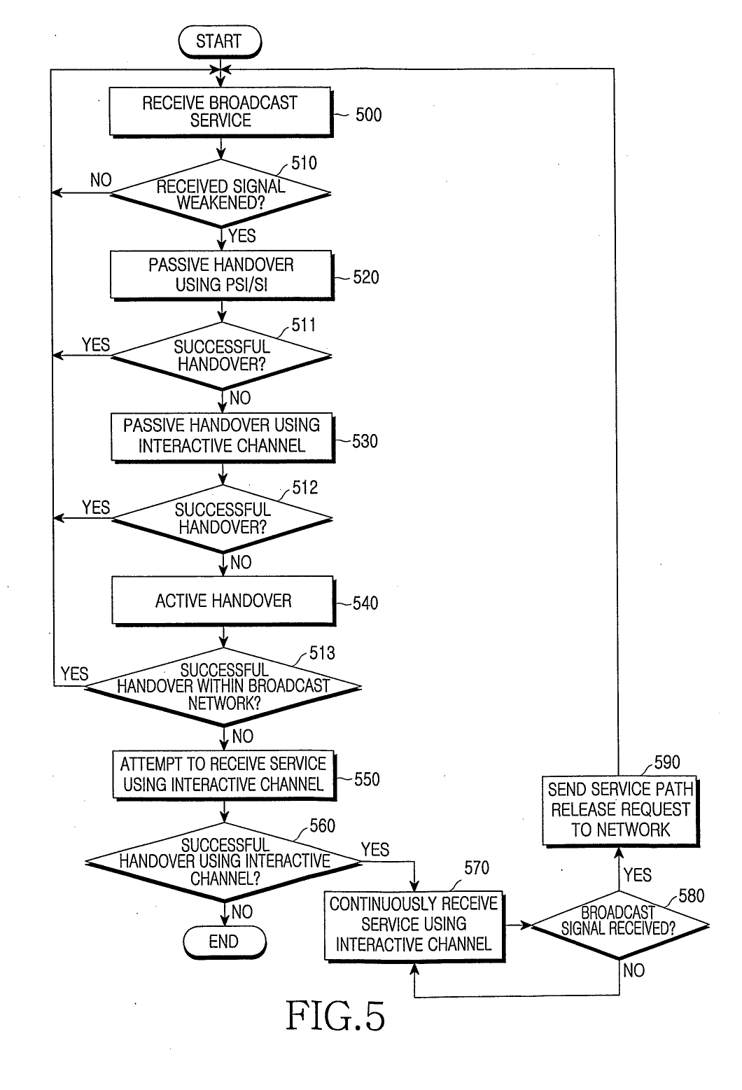

FIG. 5 is a flowchart schematically illustrating a handover procedure in accordance with an exemplary embodiment of the present invention.

Referring to FIG. 5, a terminal receives a broadcast service in step 500 and periodically measures the strength of a received signal in step 510. If the strength of the received signal remains greater than a predefined threshold, the terminal continues to receive the broadcast service in step 500. However, if the strength of the received signal falls below the predefined threshold, the terminal determines that the received signal has been weakened. That is, if the terminal determines that the received signal has been weakened, the terminal's current location is generally at a cell edge, indicating that the terminal should retrieve a new cell and perform the handover procedure. For this, the terminal selects a handover cell using PSI/SI, evaluates the signal strength received from the selected cell, and performs the handover procedure in step 520. That is, a passive handover using PSI/SI is performed. In step 511, the terminal determines whether the handover has succeeded and acquires handover-related information from the PSI/SI. If the passive handover has succeeded, the terminal continuously receives a selected service in step 500. However, if the passive handover using the PSI/SI has failed, the terminal performs a passive handover procedure using an interactive channel in step 530.

Many handovers can be performed in a passive handover scheme using the PSI/SI. However, when a type of PSI/SI table is optional according to the system, the success of the handover may be not ensured. When the strengths of signals received from all candidate cells are measured through the PSI/SI, a signal that is greater than a threshold may not be detected. Under the support of the network, the passive handover using the interactive channel is performed for the terminal. The passive handover using the interactive channel consumes a more resources than using the PSI/SI. However, because the terminal can acquire unknown network information using the interactive channel, the probability of success and efficiency of the handover increases.

If the handover-related information is acquired from the network, and the passive handover is determined to be successful in step 512, the terminal continuously receives the selected service in step 500. However, if the passive handover using the interactive channel has failed, the terminal performs an active handover procedure in step 540.

The IPDC service network controls the active handover and actively intervenes in the active handover, which is different from the passive handover. The network separates a service being watched by the user requesting the handover from an entire multiplex, changes a transport channel when surplus broadcast bandwidth is available, and provides information regarding the changed channel on which the user requesting the handover can receive the service being watched. When the user requesting the handover accepts this handover, the network provides the service through a temporarily defined channel.

In step 513, the terminal determines whether the handover has succeeded within the broadcast network. If the handover is determined to be successful, because surplus broadcast bandwidth is available, the terminal continuously receives the selected service in step 500. However, if the active handover has failed, the terminal attempts to receive the service using the interactive channel in step 550. The service is received through the interactive channel when the service cannot be provided through the broadcast network. The user can seamlessly receive the selected service through the interactive channel.

In step 560, the terminal determines whether the handover through the interactive channel has succeeded. If the handover through the interactive channel is determined to be successful, the terminal continuously receives the service using the interactive channel in step 570. However, if the handover through the interactive channel has failed, the terminal stops the service reception, upon determining that any connections to the broadcast network and the mobile communication network are impossible.

The terminal determines whether a broadcast signal is periodically received in step 580, while receiving the service in step 570. If the broadcast signal is not received, the terminal continuously receives the service in step 570. However, if the broadcast signal is received, the terminal receives the broadcast service in step 500, after providing the network with a request for releasing a path of the service being watched in step 590. Upon receiving the service path release request, the network releases the associated path in operation up to now.

The above-described handover procedure is set to perform the handover while minimizing resource consumption by first performing the simplest scheme. An application of a method proposed in exemplary embodiments of the present invention is not limited to the above-described sequence. For example, when the handover using the PSI/SI has failed in FIG. 5, an attempt for the active handover can be immediately made without an attempt for the passive handover.

Next the passive and active handover procedures will be described in detail.

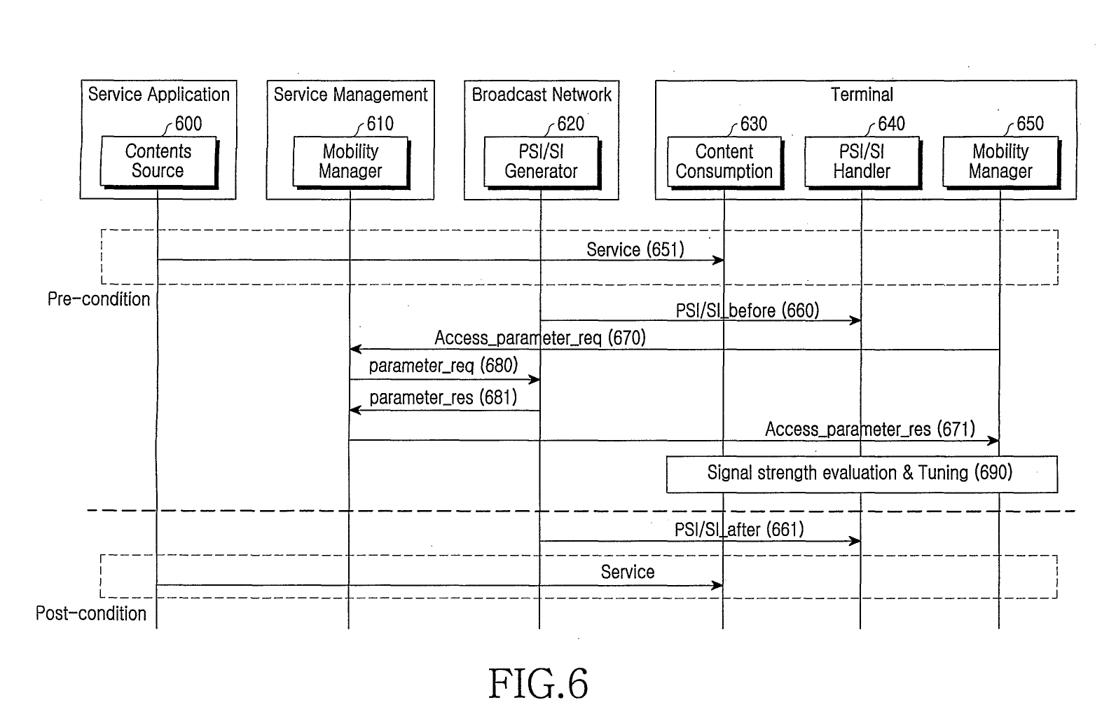

FIG. 6 is a flow diagram illustrating a message exchange procedure for a passive handover in accordance with an exemplary embodiment of the present invention.

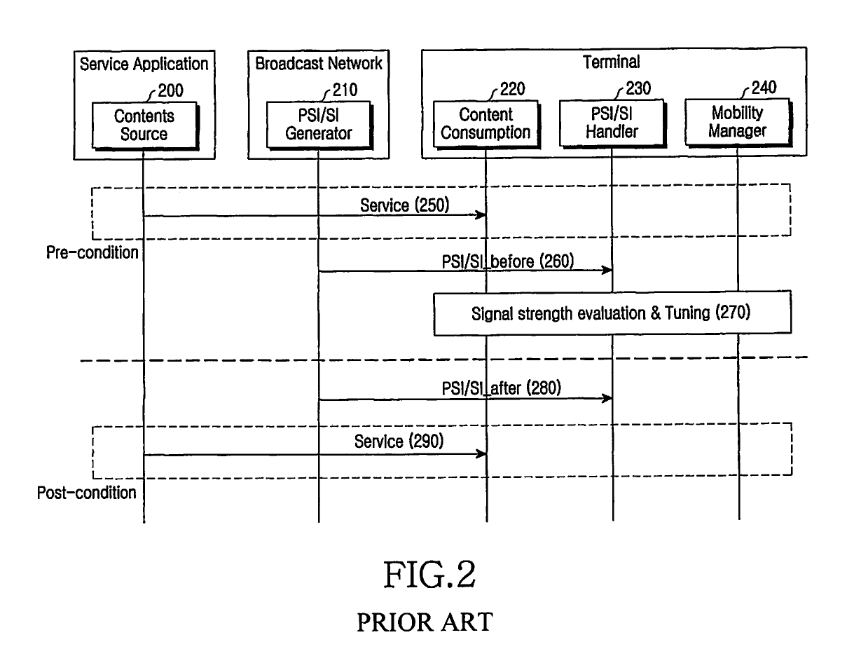

Entities, excluding a mobility manager 610 of a service management for performing the passive handover as illustrated in FIG. 6, are the same as those illustrated in FIG. 2. Accordingly, a repeated description of the same entities, such as Content Consumption 630 and PSI/SI Handler 640, is omitted.

Referring to FIG. 6, the mobility manager entity 610 receives an access parameter request message from a terminal and sends a parameter request message for requesting that a PSI/SI generator entity 620 within a broadcast network should provide information mapped to the requesting terminal.

Next, a message exchange procedure upon the handover in accordance with an exemplary embodiment of the present invention will be described.

Referring to FIG. 6, the terminal receives a service from a contents source 600 and receives a selected program before a handover state is entered in step 651. When the strength of a received signal is weakened, the terminal selects candidate cells suitable for its location on the basis of PSI/SI (PSI/SI_before) provided from the PSI/SI generator 620 and measures signal strengths received from the candidate cells during an off time in step 660. If the terminal has failed to acquire the PSI/SI, or it is difficult to perform the handover only using the provided PSI/SI, the terminal sends a message (Access_parameter_req) requesting that the mobility manager 610 of the service management transmits an access parameter corresponding to required information through an interactive channel in step 670. The transmitted access parameter request message may be constructed as shown in Table 1.

TABLE 1

Hand_over_type
Terminal_id
Service_id
Cell_id
Loc_inf (optional)

In Table 1, the first item, Hand_over_type, indicates a type of handover requested by the terminal. If the type of handover requested by the terminal is the passive handover, the network supports the handover by providing the terminal with information without varying a current service configuration. When the width of selection capable of being requested by the terminal within a range of the passive handover is wide, a type of requested information can be identified using the element of Hand_over_type.

The second item, Terminal_id, is an IDentifier (ID) of the terminal requesting the handover within the mobile communication network. The ID is used when the network identifies the requesting terminal and is used when the network sends a response to the request of the terminal. If interworking with the mobile communication network is possible, the broadcast network or service provider can acquire location information of the user from the mobile communication network through the ID.

The third item, Service_id, is an ID of a service currently being received by the requesting terminal. The ID uses a service ID defined in a DVB service standard and becomes a criterion for sorting only an associated cell when enabling the network to select candidate cells. When an associated service cannot be broadcast in a region to which the user moves, the service ID can be used to propose an alternative service. For example, when the user is currently watching a regional news program, a news program of a region to which the user moves is provided as the alternative service.

The fourth item, Cell_id, is an ID for indicating a cell of the broadcast network where the requesting terminal is currently receiving. The fourth item of Cell_id can be a criterion for transmitting PSI/SI from the network that detects a position of a cell where the requesting terminal is located.

The fifth item, Loc_inf, is an optional element and can be used to select required information in the network when the requesting terminal can exactly know its location through an additional device, such as a Global Positioning System (GPS), and can notify the network of a current traveling direction and location information of the terminal.

The mobility manager entity 610 within the service management receives an access parameter request message in step 670 and provides the PSI/SI generator 620 with a parameter request message (Parameter_req) for requesting information mapped to the requesting terminal in step 680.

The PSI/SI generator 620 within the broadcast network provides the mobility manager 610 of the service management entity with a parameter response message (Parameter_res) as a reply to the parameter request message in step 681.

The mobility manager 610 within the service management provides the mobility manager 650 of the requesting terminal with an access parameter response message (Access_parameter_res) in step 671.

In step 690, the terminal measures signal strengths received from neighbor cells during an off time on the basis of the information and performs a handover procedure by tuning a frequency when a suitable cell is retrieved. After the handover is performed, the terminal continuously receives PSI/SI from a new cell and continuously retrieves and receives a transport stream to be received in step 661. If the handover to a different network is performed, a roaming procedure is performed, after tuning the frequency in step 690. The detailed roaming procedure and method may conform to a disclosure of Korean Patent Application No. 2006-3684 entitled “Method and System for User and Service Roaming in a Digital Video Broadcasting System”.

After completing step 661, the terminal receives a service from the new cell in step 691, such that the user can seamlessly continuously receive the selected service.

Next, messages transmitted in steps 680, 681, and 671 in accordance with exemplary embodiments of the present invention will be described in detail.

### First Exemplary Embodiment

A parameter request message to be transmitted in accordance with a first exemplary embodiment of the present invention is shown in Table 2.

TABLE 2

Service_id
Request_type
Cell_id
Loc_inf (optional)

In Table 2, the first item, Service_id, is an ID assigned to identify an information request and is used to identify the case where two entities frequently exchange a message.

The second item, Request_type, is used when the mobility manager 610 notifies the PSI/SI generator 620 of a type of requested information.

The third item, Cell_id, is an ID for indicating a cell of the broadcast network to which the requesting terminal belongs. The PSI/SI generator 620 sorts only information mapped to Cell_id among the entire broadcast network information and sends the sorted information to the mobility manager 610.

The fourth item, Loc_inf, is location information of the terminal as additional information and is used as reference material when information to be transmitted is selected.

A parameter response message to be transmitted in accordance with the first exemplary embodiment of the present invention is shown in Table 3.

TABLE 3

Service_id
Neighbor_cell_descriptor
. . .
Neighbor_cell_descriptor

Table 3 is constructed with PSI/SI capable of being received in a region where the requesting terminal is located, and is used to provide the terminal with required information like the conventional PSI/SI. In this case, because the system considers the handover, efficiency can increase by eliminating unrelated information from information to be provided. The first item, Service_id, in Table 3 is the same as that of Table 2.

An access parameter response message to be transmitted in accordance with the first exemplary embodiment of the present invention is shown in Table 4.

TABLE 4

Neighbor_cell_descriptor
. . .
Neighbor_cell_descriptor

Table 4 is constructed with PSI/SI capable of being received in a region where the requesting terminal is located. Because the items of Table 4 are the same as those of Table 3, a repeated description is omitted herein.

### Second Exemplary Embodiment

An access parameter request message to be transmitted in accordance with a second exemplary embodiment of the present invention is shown in Table 5.

TABLE 5

Service_id
Request_type
Cell_id
Loc_inf (optional)

In Table 5, the first item, Service_id, is an ID assigned to identify an information request and is used to identify the case where two entities frequently exchange a message.

The second item, Request_type, is used when the mobility manager 610 notifies the PSI/SI generator 620 of a type of requested information.

The third item, Cell_id, is an ID for indicating a cell of the broadcast network to which the requesting terminal belongs. The PSI/SI generator 620 sorts only information mapped to Cell_id among the entire broadcast network information and sends the sorted information to the mobility manager 610.

The fourth item, Loc_inf, is location information of the terminal as additional information and is used as reference material when information to be transmitted is selected.

A parameter response message to be transmitted in accordance with the second exemplary embodiment of the present invention is shown in Table 6.

TABLE 6

Service_id
Cell_id
Frequency_list_descriptor
Hand_over_available_time
Cell_id
Frequency_list_descriptor
Hand_over_available_time
. . .
Cell_id
Frequency_list_descriptor
Hand_over_available_time

Table 6 is constructed with information regarding a cell ID of a region where the requesting terminal can receive, a frequency list of an associated cell and time required to receive a full IP packet. When the information is classified according to type, candidate cell information, frequency information of a candidate cell, and additional useful information for the handover are provided. An example of the additional useful information for the handover has been described as the time information of Hand_over_available_time for completing the handover to receive a full packet in the requesting terminal. Useful information for a different handover can be also provided in a scheme proposed in exemplary embodiments of the present invention when Hand_over_type and a message format are designated.

An access parameter response message to be transmitted in accordance with the second exemplary embodiment of the present invention is shown in Table 7.

TABLE 7

Cell_id
Frequency_list_descriptor
Hand_over_available_time
Cell_id
Frequency_list_descriptor
Hand_over_available_time
. . .
Cell_id
Frequency_list_descriptor
Hand_over_available_time

### Third Exemplary Embodiment

A parameter request message to be transmitted in accordance with a third exemplary embodiment of the present invention is shown in Table 8.

TABLE 8

Service_id
Request_type
Cell_id
Loc_inf (optional)

In Table 8, the first item, Service_id, is an ID assigned to identify an information request and is used to identify the case where two entities frequently exchange a message.

The second item, Request_type, is used when the mobility manager 610 notifies the PSI/SI generator 620 of a type of requested information.

The third item, Cell_id, is an ID for indicating a cell of the broadcast network to which the requesting terminal belongs. The PSI/SI generator 620 sorts only information mapped to Cell_id among the entire broadcast network information and sends the sorted information to the mobility manager 610.

The fourth item, Loc_inf, is location information of the terminal as additional information and is used as reference materials when information to be transmitted is selected.

A parameter response message to be transmitted in accordance with the third exemplary embodiment of the present invention is shown in Table 9.

TABLE 9

Service_id
Cell_id
Frequency_list_descriptor
Hand_over_available_time
Cell_id
Frequency_list_descriptor
Hand_over_available_time
. . .
Cell_id
Frequency_list_descriptor
Hand_over_available_time

Table 9 is constructed with information regarding a cell ID of a region in which the requesting terminal can receive a frequency list of an associated cell, a time required to receive a full IP packet, and candidate cells inspected and selected in the network, when the number of candidate cells accessible from the terminal is large. When the information is classified according to types, candidate cell information, frequency information of a candidate cell and additional useful information for the handover are provided.

An access parameter response message to be transmitted in accordance with the third exemplary embodiment of the present invention is shown in Table 10.

TABLE 10

Cell_id
Frequency_list_descriptor
Hand_over_available_time
Cell_id
Frequency_list_descriptor
Hand_over_available_time
. . .
Cell_id
Frequency_list_descriptor
Hand_over_available_time

The third exemplary embodiment of the present invention is different from the second exemplary embodiment in that the third exemplary embodiment of the present invention selects a dominant candidate cell and sends information regarding the selected dominant candidate cell when the number of candidate cells accessible from the terminal is large, which is different from the second exemplary embodiment. When interworking with the mobile communication network is possible, the broadcast service network can detect the physical location of the requesting terminal using the Cell_id information provided by the requesting terminal and the Loc_inf information provided by the mobile communication network. When an access parameter is provided, information regarding all cells of the broadcast network is not transmitted, but only information regarding a neighbor cell at the location of the requesting terminal can be selected and transmitted. In this case, the number of handover candidate cells can be reduced for the terminal requesting the handover. Consequently the handover procedure can be simplified. However, in the first to third exemplary embodiments of the present invention, additional information is present upon transmission of the Access_parameter_res message in the case of the handover to a different network.

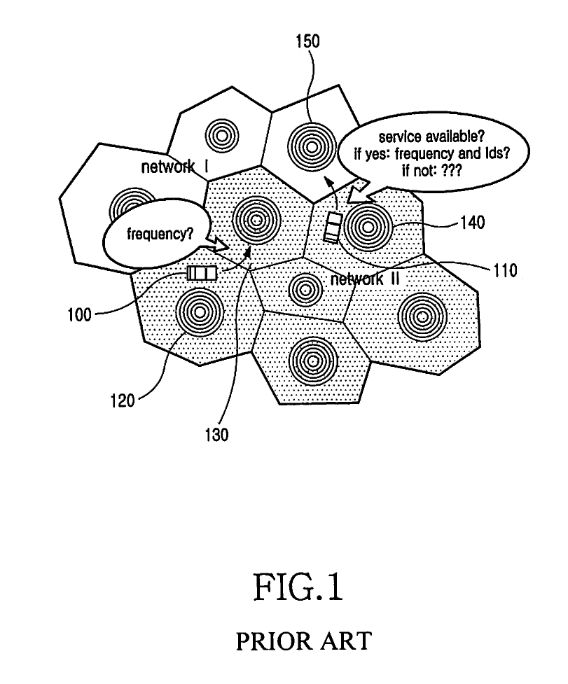

In the handover to a different network, as described with reference to FIG. 1, a service is retrieved, which is the same as a service being watched, such that the user can continuously watch the service. When the same service cannot be provided, an alternative service is retrieved such that the user can watch the service. There is the case where roaming is required. Thus, when the handover to a different network is performed in the exemplary embodiments of the present invention, information required for the handover to a different network can be additionally transmitted in the Access_parameter_res message. For example, the additional information can be a service ID of an alternative service, a Uniform Resource Identifier (URI) or Uniform Resource Locator (URL) of the different network for roaming, a roaming fee guide, etc. If a handover target cell is located in a different network, a cell ID is replaced with a network ID, such that identification is possible. In the case of the handover to the different network, an Access_parameter_res message for transmitting the additional information in accordance with an exemplary embodiment of the present invention is shown in Table 11.

TABLE 11

Alternative_service_id
Different_network_URL
Roaming_fee_inf

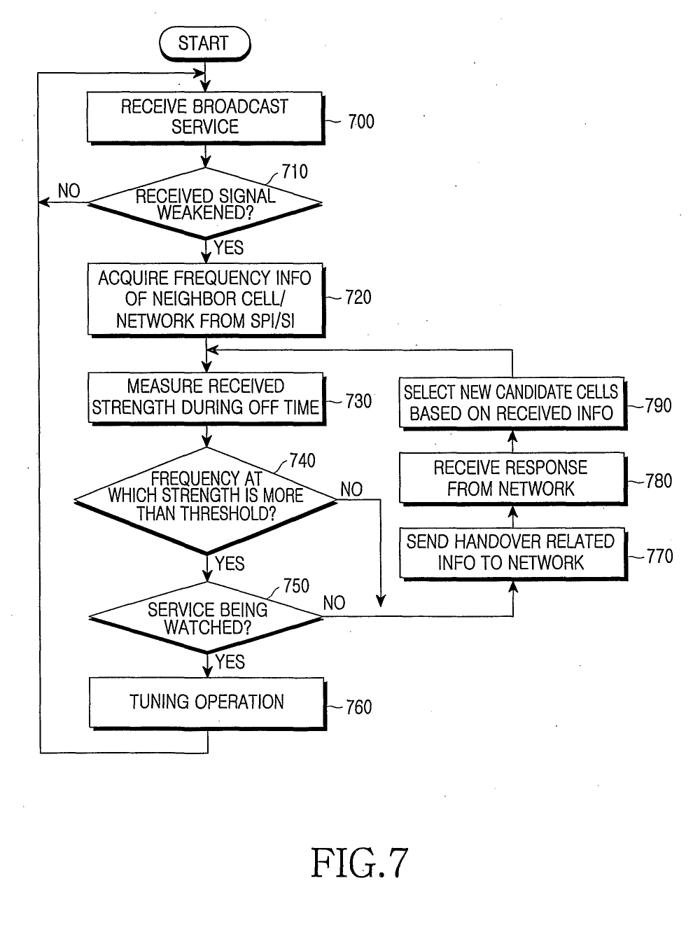

FIG. 7 is a flowchart illustrating an operation of the terminal upon the passive handover in accordance with an exemplary embodiment of the present invention.

Referring to FIG. 7, the terminal receives a broadcast service in step 700 and periodically determines whether the strength of a received signal is weakened in step 710. If the received signal strength is not weakened, the terminal continuously receives the broadcast service in step 700. However, if the received signal strength is weakened, the terminal acquires frequency information of a neighbor cell or network from PSI/SI in step 720. The cell or network whose frequency information is known belongs to a candidate group for the handover.

Upon acquiring the frequency information from the PSI/SI, the terminal measures the signal strength received from the neighbor cell or network during an off time in step 730. If a frequency is retrieved at a received signal strength greater than a predefined threshold in step 740, the terminal determines whether a service being watched by the user is present at the frequency in step 750. Steps 700 to 750 are the same as those of the conventional handover using PSI/SI. The handover for the terminal can be performed even when the passive handover using an interactive channel is performed immediately after step 710. Of course, an up-and-down relation in the procedure can be changed.

However, if a frequency at which the received signal strength is greater than the predefined threshold is determined to be absent in step 740, the terminal sends a request for handover-related information to the network in step 770. Because the handover for the terminal cannot be performed using only information acquired from the broadcast network, the terminal requests the help of the network in step 770. The request process is performed using the interactive channel. Various embodiments may be provided according to the needs of the terminal.

After completing step 770, the terminal receives requested information through the interactive channel by receiving a response from the network in step 780. Upon receiving the response from the network in step 780, the terminal selects a new handover candidate cell on the basis of the acquired information in step 790. As the new candidate cell is selected, the procedure returns to step 730.

If step 770 is reached in the scheme illustrated FIG. 7, compared with the conventional scheme, it means that the conventional handover using PSI/SI for the terminal has failed. In the conventional handover scheme, there is no method other than a method for again retrieving a user requested service through an initial setup process. However, in the passive handover scheme proposed in exemplary embodiments of the present invention, the terminal acquires information required for the handover through a series of processes (for example, steps 770 to 790) for sending a handover-related information request to the network and receiving a response and repeats steps 730 to 750, such that a suitable candidate cell can be retrieved, and a handover procedure can be performed.

If the service being watched by the user is present at the frequency at a received signal strength higher than the threshold in step 750, the terminal performs a tuning operation in step 760. The tuning operation enables the service to be continuously received by shifting a reception frequency and detecting an associated transport stream being watched by the user. After step 760, the handover process is completed. The terminal continuously receives the service in step 700.

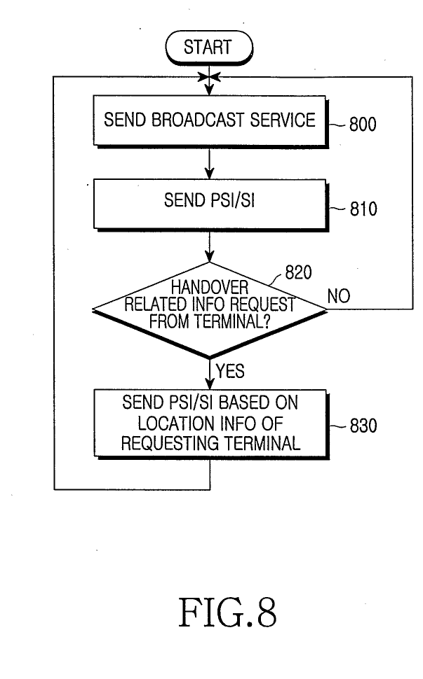

FIG. 8 is a flowchart illustrating an operation of the network upon the passive handover in accordance with an exemplary embodiment of the present invention.

Referring to FIG. 8, the network transmits a broadcast service in step 800 and simultaneously transmits PSI/SI in step 810. The network periodically determines whether a handover-related information request is received from a terminal through an interactive channel in step 820, while performing steps 800 and 810. When a request from the terminal is absent, the network periodically performs the determination process of step 820 while repeating steps 800 and 810. When the handover-related request is received from the terminal, the network sends PSI/SI based on location information of the requesting terminal in step 830. Various embodiments can be provided in step 830. An exemplary embodiment of step 830 has been described above with reference to FIG. 6.

Next, the active handover in accordance with an exemplary embodiment of the present invention will be described in detail.

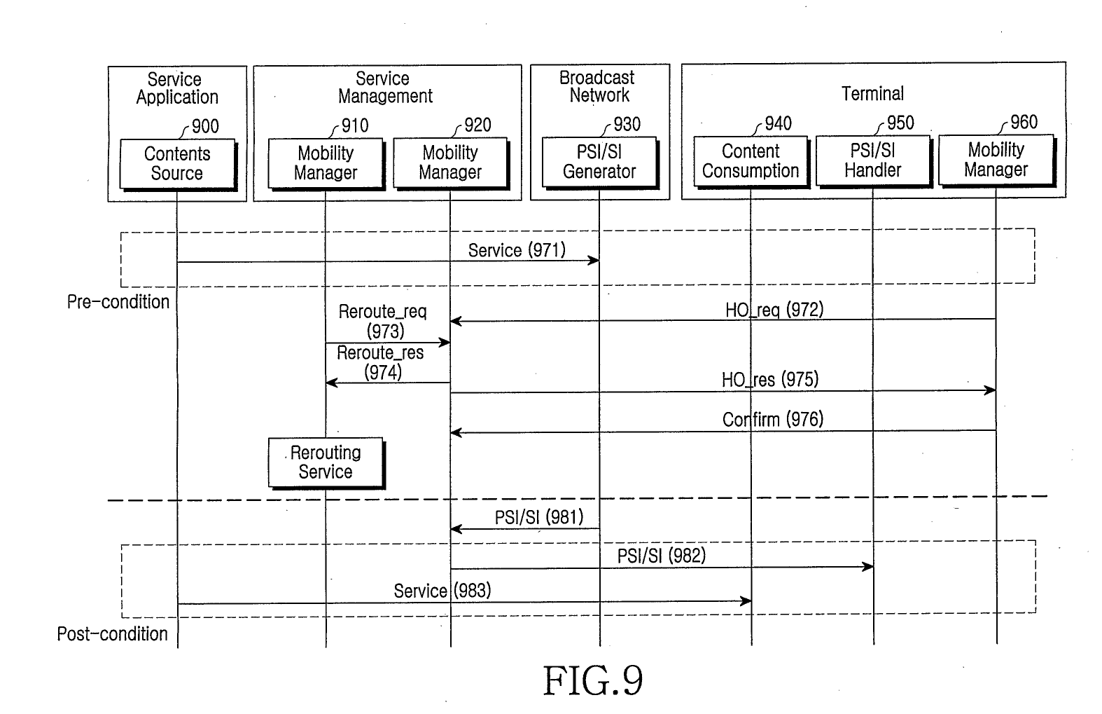

FIG. 9 is a flow diagram illustrating a message exchange procedure during an active handover in accordance with an exemplary embodiment of the present invention.

Entities, excluding a resource allocation 910 of a service management required to perform the active handover as illustrated in FIG. 9, are the same as those illustrated in FIG. 6. Accordingly, a repeated description of the same entities, such as PSI/SI Generator 930, Content Consumption 940, PSI/SI Handler 950, and Mobility Manager 960, is omitted. The resource allocation 910 is responsible for resource distribution of an IPDC service network.

A message exchange procedure upon the active handover in accordance with an exemplary embodiment of the present invention is as follows.

Referring to FIG. 9, a terminal receives a service from the contents source 900 and receives a selected program before a handover state is entered in step 971. When the strength of a received signal is weakened, the terminal attempts a handover using the conventional passive handover scheme. If the passive handover for the terminal has failed, the terminal sends an active handover request (HO_req) to the network in step 972. Because a method for connecting the terminal to the network through an interactive channel departs from the scope of the present invention, a detailed description is omitted herein.

The format of a message to be transmitted in step 972 is shown in Table 12.

TABLE 12

Hand_over_type
Terminal_type
User_id
Service_id
Cell_id
Loc_inf (optional)

Referring to Table 12, the first item, Hand_over_type, contained in the message, indicates a type of handover requested by the terminal. If the type of handover requested by the terminal is the active handover, the network supports the handover for the terminal by varying a current service configuration. When the width of selection capable of being requested by the terminal within a range of the active handover is wide, a type of requested information can be identified using the element of Hand_over_type.

The second item, Terminal_id, is an ID of the terminal requesting the handover within the mobile communication network. The ID is used when the network identifies the requesting terminal and is used when the network sends a response to the request of the terminal. If the interworking with the mobile communication network is possible, the broadcast network or service provider can acquire location information of the user from the mobile communication network through the ID.

The third item, User_id, is an ID for identifying a user requesting the active handover.

The fourth item, Service_id, is an ID for identifying a service currently being received by the terminal requesting the handover. The ID uses a service ID defined in a standard for a DVB service and is used to indicate a service for which the network creates a special path.

The fifth item, Cell_id, is an ID for indicating a cell of the broadcast network in which the terminal requesting the handover is currently receiving. The ID becomes a criterion when the network detects a position of a cell to which the terminal requesting the handover belongs and provides a method proper for a current situation.

The sixth item, Loc_inf, is an optional element and can be used to take necessary action in the network when the requesting terminal can exactly know its location through an additional device, such as a GPS, and can notify the network of a current traveling direction and location information of the terminal.

The mobility manager 920 within the service management receives an active handover request from the terminal in step 972, and then provides the resource allocation 910 within the service management with an active handover request (Reroute_req) in step 973. At this time, information required to support the handover for the terminal requesting the handover is transmitted. In this case, a format of a message to be transmitted is shown in Table 13.

TABLE 13

User_id
Service_id
Cell_id
Loc_inf

In Table 13, User_id is an ID for identifying a user requesting the handover, Service_id is an ID for identifying a service being watched by the user requesting the handover, Cell_id is an ID for indicating a cell of the broadcast network in which the terminal requesting the handover is currently receiving, and Loc_inf is location information as additional information of the terminal and is used as reference materials when information to be transmitted is selected.

In step 974, the resource allocation 910 within the service management provides the mobility manager 920 with an active handover response (Reroute_res) to the active handover request of step 973. In this case, a format of a message to be transmitted is shown in Table 14.

TABLE 14

User_id
Change_channel_id
Change_time

As shown in Table 14, the active handover response message to the active handover request message is constructed with information required to perform the handover for the terminal requesting the handover and contains required information for enabling the terminal to receive a service to be changed. When a resource of the broadcast network is not available, the resource allocation 910 notifies that the active handover cannot be performed.

User_id of Table 14 is the same as that of Table 13. In Table 14, Change_channel_id indicates information regarding a channel to be changed when the active handover is performed, and Change_time indicates information regarding a time at which the channel is changed by performing the active handover.

After the above-described process is completed, the mobility manager 920 within the service management provides the terminal requesting the handover with a response message (HO_res) to the handover request in step 975. In this case, a format of a message to be transmitted is shown in Table 15.

TABLE 15

Change_channel_id
Change_time

As shown in Table 15, the response message to the handover request notifies a channel to be changed and a change time when the active handover for the terminal requesting the handover is performed. That is, Change_channel_id indicates information regarding a channel to be changed when the active handover is performed, and Change_time indicates information regarding a time at which the channel is changed by performing the active handover.

In another exemplary embodiment of the present invention, the channel to be changed can be the interactive channel rather than the broadcast network. In another exemplary embodiment of the present invention, the network can use the message of the above-described format in a method for notifying the terminal of a service change when a change such as service remapping of the network is made.

After receiving the response message in step 975, the terminal sends a Confirm message for accepting the active handover to the network in step 976. The format of the Confirm message can contain only User_id and acknowledge information.

After receiving the Confirm message, the network performs a process for rerouting a service. Then, the user requesting the active handover receives the service being watched through an additional channel.

After the handover process, the mobility manager 920 within the service management receives PSI/SI from a PSI/SI generator in step 981 and provides the PSI/SI to the terminal in step 982 simultaneously when the service is provided in step 983.

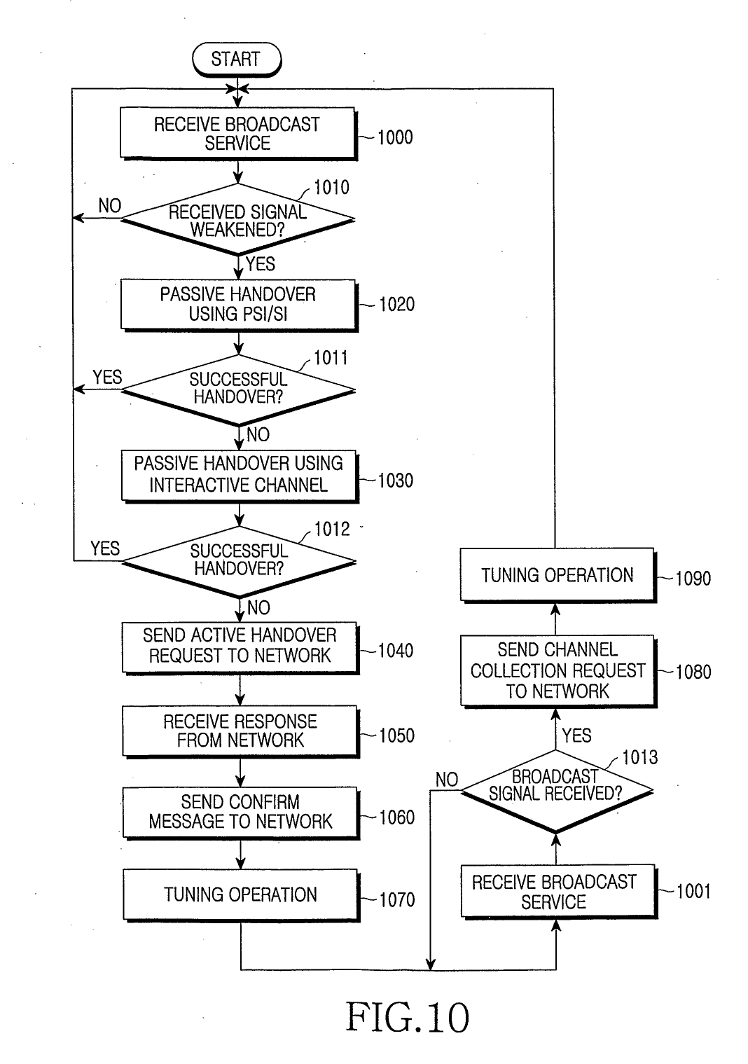

FIG. 10 is a flowchart illustrating an operation of the terminal during an active handover in accordance with an exemplary embodiment of the present invention.

Referring to FIG. 10, the terminal receives a broadcast service in step 1000 and periodically determines whether the strength of a received signal is weakened in step 1010. If the received signal strength is not weakened, the terminal continuously receives the broadcast service in step 1000. If the reception signal is weakened, the terminal attempts a passive handover using PSI/SI in step 1020.

In step 1011, the terminal determines whether the handover has succeeded. If the handover is determined to be successful by successfully acquiring associated information, the terminal returns to a broadcast service reception state of step 1000. However, if the passive handover using PSI/SI is determined to be unsuccessful in step 1011, the terminal attempts a passive handover using an interactive channel in step 1020.

In step 1012, the terminal determines whether the passive handover has succeeded. If the passive handover is determined to be successful by successfully acquiring associated information, the terminal returns to the broadcast service reception state of step 1000. However, if the passive handover using the interactive channel is determined to be unsuccessful in step 1012, the terminal sends an active handover request to a network in step 1040.

The terminal receives a response from the network in step 1050. When accepting the active handover, the terminal sends a confirm message to the network in step 1060 and performs a tuning operation for the active handover on the basis of given information in step 1070.

After completing step 1070, the terminal receives the broadcast service through a channel generated as a result of the active handover in step 1001. The terminal repeats a process for periodically retrieving a broadcast signal in step 1013. When receiving the broadcast signal in step 1013, the terminal sends a channel collection request to the network in step 1080, and after completing the tuning operation in step 1090, returns to the broadcast service reception state of step 1000.

However, if the received signal is weakened in step 1010, an attempt for the active handover can be immediately made while omitting steps 1020, 1011, 1030, and 1012.

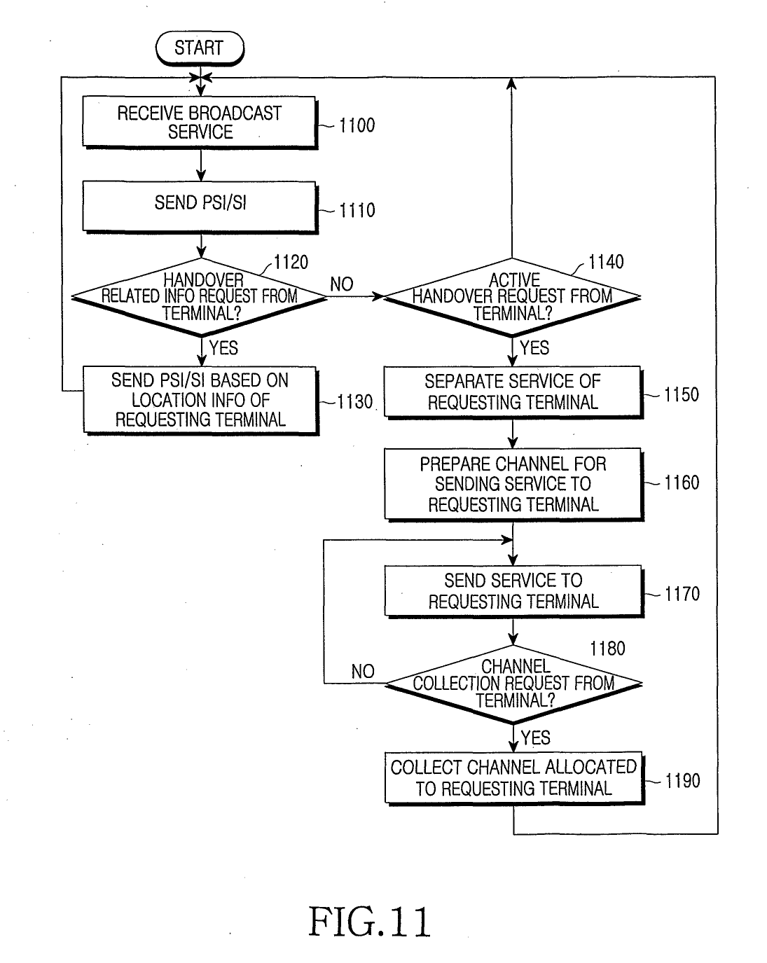

FIG. 11 is a flowchart illustrating an operation of the network during an active handover in accordance with an exemplary embodiment of the present invention.

Referring to FIG. 11, the network transmits a broadcast service in step 1100, and simultaneously transmits PSI/SI in step 1110. The network periodically determines whether a handover-related information request is received from a terminal through an interactive channel in step 1120 while performing steps 1100 and 1110. If the request is received from the terminal, the network sends PSI/SI based on location information of the requesting terminal in step 1130. However, if a request from the terminal is determined to be absent, the network periodically determines whether an active handover request is received from the terminal through the interactive channel in step 1140. If the active handover request is received from the terminal, a service of the terminal requesting the handover is separated from an entire multiplex in step 1150, and a channel to be provided to the terminal requesting the handover is prepared in step 1160. Then, the network provides the terminal requesting the handover with the service in step 1170. Then the network periodically determines whether a request for collecting a given channel is received from the terminal in step 1180. If the channel collection request is received from the terminal, the network collects the channel allocated to the terminal requesting the handover and completes the active handover process in step 1190.

As is apparent from the description above, the present invention provides at least the following advantages.

The present invention provides a seamless service when a user terminal moves out of an old cell or network and enters a new cell or network while watching a selected service using an interactive channel in a DVB-H CBMS system.

Moreover, the present invention reduces a handover time and power consumption of the terminal by reducing the number of handover candidate cells for the terminal by making use of the interactive channel.

While the present invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method for performing a handover for a terminal in a Digital Video Broadcasting Handheld (DVB-H) Convergence of Broadcasting and Mobile Service (CBMS) system, comprising:
checking a received strength of a broadcast service currently being received;
sending a request for handover-related information from the terminal to a network through an interactive channel;
selecting new handover candidate cells based on the handover-related information received from the network through the interactive channel;
measuring strengths of broadcast service signals received from the candidate cells;
performing a tuning operation for detecting a transport stream of the service currently being received by shifting a reception frequency to a retrieved frequency; and
continuously receiving the service currently being received.

2. The method of claim 1, further comprising:
sending the request for the handover-related information when the broadcast service currently being received by the terminal is not provided at the retrieved frequency.

3. The method of claim 1, wherein the handover-related information is Program Specific Information (PSI)/Service Information (SI) of a cell and a network in which the terminal is located.

4. The method of claim 1, wherein the handover-related information includes at least one of information regarding a candidate cell in a region in which the terminal can receive at its current location, information regarding a time required to receive an Internet protocol packet, and information regarding a dominant candidate cell of multiple candidate cells accessible from the terminal.

5. The method of claim 1, wherein sending the request for the handover-related information comprises:
checking the received strength of the broadcast service currently being received by the terminal;
acquiring frequency-related information of candidate cells suitable for location of the terminal on a basis of Program Specific Information (PSI)/Service Information (SI);
measuring strengths of broadcast service signals received from the candidate cells;
determining if the broadcast service currently being received by the terminal is present at a frequency when the frequency is retrieved at a strength greater than a reference value; and
sending the request for the handover-related information of a region in which the terminal is located to the network through an interactive channel when the frequency is not retrieved at the strength greater than the reference value, or when the broadcast service currently being received by the terminal is not provided at the retrieved frequency.

6. A method for supporting a handover for a terminal in a network of a Digital Video Broadcasting Handheld (DVB-H) Convergence of Broadcasting and Mobile Service (CBMS) system, comprising:
transmitting a broadcast service and Program Specific Information (PSI)/Service Information (SI);
receiving a message requesting handover-related information from the terminal through an interactive channel; and
transmitting the broadcast service, the PSI/SI, and the handover-related information through the interactive channel.

7. The method of claim 6, wherein the handover-related information includes at least one of information regarding a candidate cell in a region where the terminal can receive at its current location, information regarding a time required to receive an Internet protocol packet, and information regarding a dominant candidate cell of multiple candidate cells accessible from the terminal.

8. A method for performing a handover for a terminal in a Digital Video Broadcasting Handheld (DVB-H) Convergence of Broadcasting and Mobile Service (CBMS) system, comprising:
checking a received strength of a broadcast service currently being received;
sending a handover request message from the terminal to a network through an interactive channel;
receiving a response to the handover request message from the network through the interactive channel;
sending a handover confirm message from the terminal to the network through the interactive channel;
performing a tuning operation for detecting a transport stream of the service currently being received by shifting a reception frequency at a time defined by channel information included in the handover confirm message; and
continuously receiving the service currently.

9. The method of claim 8, further comprising:
receiving Program Specific Information (PSI)/Service Information (SI) and the broadcast service after the handover,
sending an interactive channel collection request to the network.

10. The method of claim 8, further comprising:
checking, by the terminal, the received strength of the broadcast service currently being received;
attempting a passive handover; and
sending a handover request to the network, when the passive handover has failed,
wherein attempting the passive handover comprises:
sending a request for handover-related information from the terminal to the network through the interactive channel;
selecting new handover candidate cells based on the handover-related information received from the network through the interactive channel;
measuring strengths of broadcast service signals received from the candidate cells;
performing a tuning operation for detecting a transport stream of the service currently being received by shifting a reception frequency to a retrieved frequency; and
continuously receiving the service currently being received.

11. The method of claim 8, wherein the handover request message includes at least one of information regarding a type of the handover requested by the terminal, information regarding a identifier of the terminal requesting the handover, and information regarding a identifier of the broadcast service currently being received by the requesting terminal.

12. The method of claim 8, wherein the handover response message includes at least one of information regarding the channel and information regarding a time at which the channel is changed.

13. A method for supporting a handover for a terminal in a network of a Digital Video Broadcasting Handheld (DVB-H) Convergence of Broadcasting and Mobile Service (CBMS) system, comprising:
transmitting a broadcast service and Program Specific Information (PSI)/Service Information (SI);
receiving a handover request message from the terminal through an interactive channel;
generating a channel for providing the terminal with the broadcast service; and
providing the terminal with a handover channel identifier and handover time information along with the broadcast service through the generated channel.

14. The method of claim 13, further comprising:
receiving a request for collecting the generated channel from the terminal; and
collecting the generated channel.

15. A Digital Video Broadcasting Handheld (DVB-H) Convergence of Broadcasting and Mobile Service (CBMS) system for supporting a handover, comprising:
a terminal for requesting at least one of a passive handover and an active handover when a received strength of a service currently being received is less than a reference value; and
a network for transmitting a broadcast service and Program Specific Information (PSI)/Service Information (SI), generating a channel for providing the terminal with the broadcast service, and transmitting the broadcast service and the PSI/SI through the generated channel,
wherein the network transmits handover-related information through the generated channel when receiving the passive handover request from the terminal and provides the terminal with a handover channel identifier and handover time information along with the broadcast service through the generated channel when receiving the active handover request from the terminal.

16. The DVB-H CBMS system of claim 15, wherein the handover-related information comprises at least one of:
information regarding a candidate cell in a region where the terminal can receive at its current location;
information regarding a time required to receive an Internet protocol packet; and
information regarding a dominant candidate cell of multiple candidate cells accessible from the terminal.

17. A User Equipment (UE) for performing a handover in a Digital Video Broadcasting Handheld (DVB-H) Convergence of Broadcasting and Mobile Service (CBMS) system, comprising:
a content consumption unit for receiving a broadcast service from a broadcasting network;
a Program Specific Information (PSI)/Service Information (SI) handler for receiving the PSI/-SI from the broadcasting network; and
a mobility manager for sending a request for handover-related information from the UE to a network through an interactive channel, selecting new handover candidate cells based on the handover-related information received from the network through the interactive channel and performing a tuning operation for detecting a transport stream of the service currently being received by shifting a reception frequency to a retrieved frequency.

18. A User Equipment (UE) for performing a handover in a Digital Video Broadcasting Handheld (DVB-H) Convergence of Broadcasting and Mobile Service (CBMS) system, comprising:
a content consumption unit for receiving a broadcast service from a broadcasting network;
a Program Specific Information (PSI)/Service Information (SI) handler for receiving the PSI/-SI from the broadcasting network; and
a mobility manager for sending a handover request message from the UE to a network through an interactive channel, receiving a response to the handover request message from the network through the interactive channel, sending a handover confirm message from the terminal to the network through the interactive channel, and performing a tuning operation for detecting a transport stream of the service currently being received by shifting a reception frequency at a time defined by channel information comprised in the handover confirm message.
